(19) United States
(12) Patent Application Publication
(10) Pub. No.: US 2007/0034090 A1
(43) Pub. Date: Feb. 15, 2007

(54) Household Appliance Warning/Alert Device

(76) Inventor: Thomas L. Hendrickson JR., Fishers, IN (US)

Correspondence Address: Thomas L Hendrickson Jr, 13034 W Elster Way, Fishers, IN, 46037, US

(21) Appl. No.: 11/462,700

(22) Filed: Aug. 5, 2006

Related U.S. Application Data
(60) Provisional application No. 60/706,488, filed on Aug. 8, 2005.

(51) Int. Cl. A47J 37/12

(52) U.S. Cl. 99/344

(57) ABSTRACT

A device for providing warnings to users of household appliances having an electronic audio playback circuit (24) preprogrammed with a predetermined audio message. A power source (28) to supply power to said electronic audio playback circuit (24). A speaker or transducer (22) for converting output from said electronic audio playback circuit into audio signals. A physical displacement-activated switch (20). A housing (18) for enclosing said electronic audio playback circuit (24), speaker or transducer (22), and physical-displacement-activated switch (20). A means (26) for attaching said housing to a household appliance lid or door.

### CROSS-REFERENCE TO RELATED APPLICATIONS

This application is entitled to the benefit of Provisional Patent Application Ser. No. 60/706,488

### BACKGROUND—FIELD OF INVENTION

This invention relates to warning/alert devices, specifically to warning/alert devices used for household appliances.

### SUMMARY

This invention is a device for producing various warnings and or alerts to operators of household appliances.

### OBJECTS AND ADVANTAGES

Several objects and advantages of the present invention are:
a) to provide an aftermarket device for providing helpful warnings to users of household appliances which assists the user in completing his or her tasks related to the use of the appliance.
b) to provide a means for such warnings to be produced by ordinary usage of the appliance with minimal or no user input.
c) to provide a device which can be made in such a way as to accommodate many different household appliances aftermarket, but can also be made in such a way that it integrates with an appliance at the time an appliance is manufactured.
d) to provide a device having the aforementioned qualities and having varying aesthetic shapes, sizes and colors to add decorative and commercial advertising value to such device.

### DRAWING FIGURES

FIG. 1 is a view of a Household Appliance Warning/Alert Device attached to the lid of a typical household appliance.

FIG. 2 is a view of a Household Appliance Warning/Alert Device on an open lid of a typical household appliance.

FIG. 3 is an elevated cross sectional view of a Household Appliance Warning/Alert Device.

FIGS. 4 and 5 show alternate embodiments of my invention.

### REFERENCE NUMERALS IN DRAWINGS

18 device housing
20 displacement-activated switch
22 speaker or transducer
24 audio playback circuit
26 magnetic or adhesive attachment strip
28 power supply
30 lamp

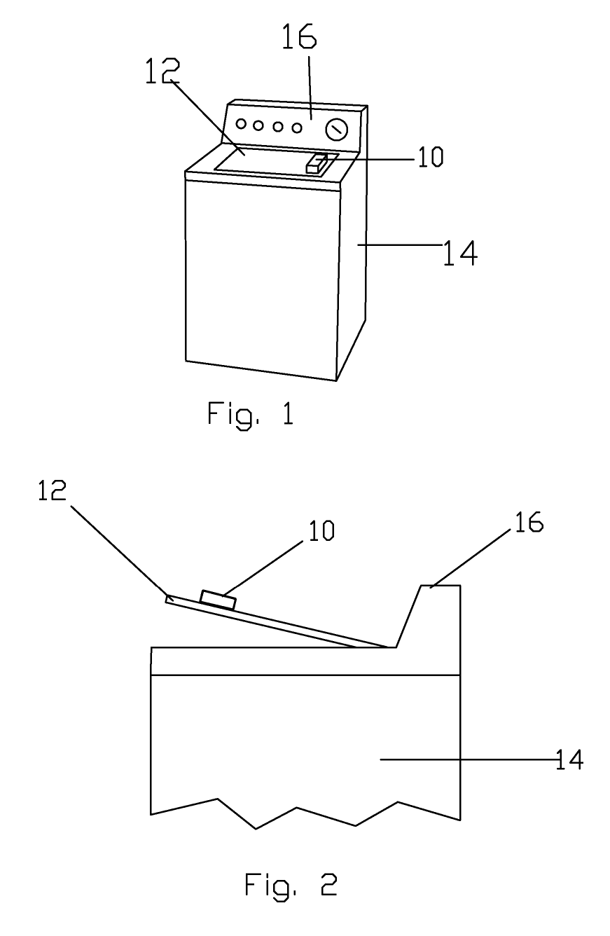

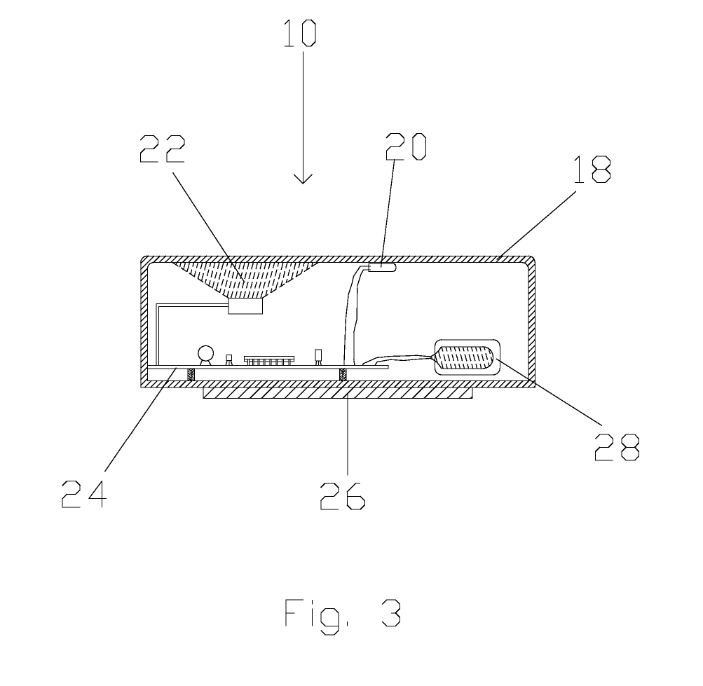

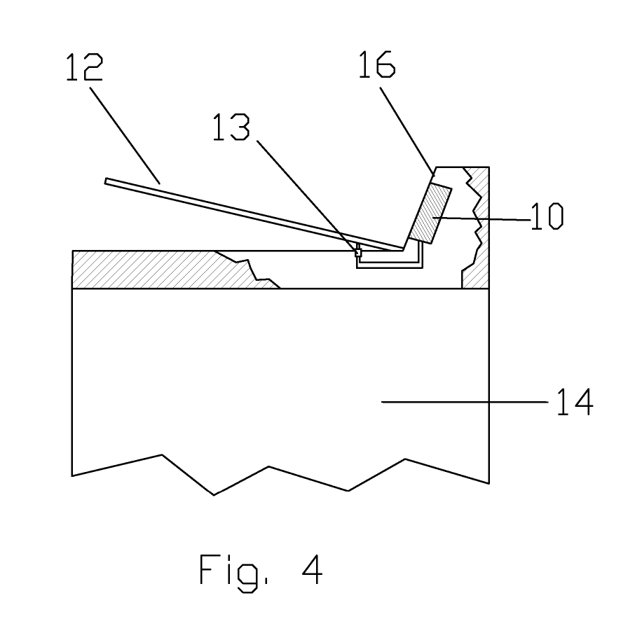

### DESCRIPTION—FIGS. 1, 2 AND 3 PREFERRED EMBODIMENT

A preferred embodiment of the device is illustrated in FIGS. 1 (view of a device attached to a closed lid of a washing machine), 2 (view of a device attached to a lid of a washing machine which has been swung open) and 3 (cross sectional view of a device).

A device 10 wherein a tilt (displacement-activated) switch 20 is electrically connected to the playback function of a digital recording circuit/module(audio playback circuit)24 which is powered by a battery(power supply) 28. The output of a digital recording circuit/module 24 is wired so that its output is directed to a speaker or transducer 22. The entire circuit is housed in a plastic or metal (housing) 18 which is attached by a magnetic or adhesive strip (means of attaching housing) 26 to the lid of an appliance 12. The tilt switch 20 is mounted to the inside of the housing in such a way that it is normally electrically open when the device is sitting horizontally on the lid 12 of a laundry washing machine 14. The tilt switch 20 is electrically connected to the playback function of the digital recording circuit/module 24. An audio message “Please empty all pockets before loading the washer” is pre-recorded to the digital recording circuit/module 24.

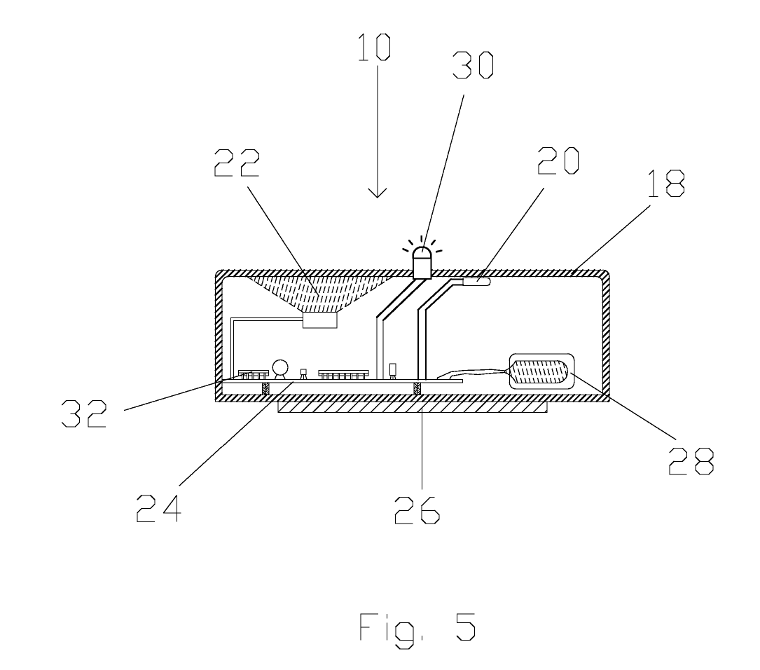

### FIG. 4—ADDITIONAL EMBODIMENT

An additional embodiment is shown in FIG. 4; FIG. 4 shows a cutaway side view of a typical laundry washing machine control panel 16. A device 10 is shown integrated into the control panel 16 of an appliance 14 and hidden from ordinary view of the user. A push button switch 13, having the properties of being normally electrically open when the lid of the appliance 12 is closed and pressing down on the switch, and electrically closed when pressure on the switch is released, is electrically connected to the playback function of the digital recording circuit/module 24. The push button switch 13 of this embodiment substitutes the tilt switch 20 of the preferred embodiment.

### FIG. 5—ADDITIONAL EMBODIMENT

An additional embodiment is shown in FIG. 5; FIG. 5 shows a device 10 as described in the preferred embodiment with the addition of lamp or light emitting diode 30 and a lamp flasher circuit 32. The lamp 30 is electrically coupled to the lamp flasher circuit 32 and tilt switch 20 in such a way that the flasher circuit 32 is activated by the tilt switch 20.

### Operation-FIGS. 1,2 and 3

The manner in which one uses the household appliance warning/alert device consists first of attaching the housing 18 of the device via the magnetic or adhesive attachment strip 26 to the lid 12 or user-movable part of an appliance. If the lid 12 of the appliance is made of a magnetic metal, the magnetic strip may be used in which case the user simply places the device 10 on the top surface of the lid 12 with the magnetic strip 26 touching the surface of the lid 12. The device 10 will be held to the surface of the lid 12 by magnetic force. When a user lifts the lid 12 of the appliance 14 to insert clothing, the device 10 is displaced along with the motion of the moving lid 12. This displacement activates the tilt switch 20 causing it to become electrically closed. The tilt switch, being electrically coupled to the audio playback circuit 24, then causes activation of the audio playback circuit 24. The audio playback circuit 24, having been preprogrammed with an audio warning message, outputs the audio message to the electrically coupled speaker or transducer 22. The speaker or transducer 22 converts the prerecorded audio message from electrical impulses to audible sound producing a message; “Please empty all pockets before loading the washer” which in turn alerts the user of the appliance to a potential problem before it is too late to correct the problem.

### CONCLUSION, RAMIFICATIONS, AND SCOPE

The reader will see the device of the invention provides the user with useful warnings relative to the use of ordinary household appliances without the need for interaction with the device once it is put into operation.

While my above description contains many specificities, these should not be construed as limitations on the scope of the invention, but rather as an exemplification of one preferred embodiment thereof. Many other variations are possible. For example the device could be attached to an oven and pre-programmed with a message which alerts users of the oven to check the contents after a specified period of time has elapsed since the oven door was opened. The device could be pre-programmed with a message which alerts users of laundry washing machines to add fabric softener after a specified time has elapsed after the lid of the laundry machine is opened.

The size and shape of the device should not be construed to be limited to the preferred embodiment, but may be any size and shape that technology will allow. For example, the device may be made in the shape of a decorative flower to add aesthetic value, or made in such a way as to hold a family photograph, giving the shape practical as well as aesthetic value.

The message of the device should not be construed to be limited to the preferred embodiment, but may be in fact any message, audible sound or in the case of one alternative embodiment, a flashing light which serves the purpose of the device.

What is claimed is:

1. Device for providing warnings to users of household appliances, the device comprising:
a) an electronic audio playback circuit preprogrammed with a predetermined audio message
b) a power source to supply power to said electronic audio playback circuit
c) a speaker or transducer for converting output from said electronic audio playback circuit into audio signals
d) a physical displacement-sensing switch connected to said electronic audio playback circuit in such a way as to activate said electronic audio playback circuit when said displacement-sensing switch is electrically closed
e) a housing for enclosing said electronic audio playback circuit, speaker or transducer, and physical displacement-sensing switch
f) means for attaching said housing to a household appliance lid or door.

2. The device of claim 1 wherein the elements of the device are integrated into a pre-determined household appliance control panel.

3. The device of claim 1 wherein the electronic audio playback circuit is digital.

4. The device of claim 1 wherein the predetermined audio message is a verbal message warning users of laundry washing machines to empty the pockets of the laundry before loading the washing machine.

5. The device of claim 1 wherein the power source is a battery

6. The device of claim 1 wherein the physical displacement-sensing switch is a tilt switch.

7. The device of claim 1 wherein the means for attaching the housing is a magnet.

8. The device of claim 1 wherein the housing is attached to a laundry washing machine lid.

9. The device of claim 1 wherein the device comprises an additional electronic circuit providing a means of producing visual warnings for users who are hearing impaired.

10. The device of claim 9 wherein the means of providing a visual warning is a lamp.

11. The device of claim 9 wherein the elements of the device are integrated into a predetermined household appliance control panel.
